(19) United States
(12) Patent Application Publication
(10) Pub. No.: US 2017/0262706 A1
(43) Pub. Date: Sep. 14, 2017

(54) SMART TRACKING VIDEO RECORDER

(71) Applicant: Intel Corporation, Santa Clara, CA (US)

(72) Inventors: Hongmei Sun, Beijing (CN); Jiqiang Song, Beijing (CN); Chao Zhang, Beijing (CN); Zhanglin Liu, Beijing (CN)

(21) Appl. No.: 15/121,596

(22) PCT Filed: Sep. 25, 2015
(86) PCT No.: PCT/CN2015/090787

§ 371 Date: Aug. 25, 2016

(51) Int. Cl. G06K 9/00; H04N 5/91; H04N 7/18; G11B 27/19; G11B 27/031

(52) U.S. Cl. CPC G06K 9/00751; G11B 27/19; G11B 27/031; H04N 7/181; H04N 5/91

(57) ABSTRACT

Various systems and methods for processing video are described herein. A system comprises a storage device; a processor; and a memory, including instructions, which when executed on the processor, cause the processor to: receive a time interval, the time interval divided into a plurality of segments; access from the storage device, a plurality of video clips, each of the plurality of video clips including a timestamp; for each of the plurality of segments in the time interval, determine a candidate video clip of the plurality of video clips, the candidate video clip including a subject in the candidate video clip; compose an output video that includes the candidate video clip of each segment of the plurality of segments; and output the output video to a display.

### TECHNICAL FIELD

Embodiments described herein generally relate to video cameras and recording and in particular, to a system for smart tracking video recorder.

### BACKGROUND

Video surveillance and monitoring has become more popular in recent history. The first video surveillance systems (also referred to as closed-circuit television (CCTV)) was first used with constant monitoring because there was no way to record or store information. The development of storage devices (e.g., reel-to-reel media and then later videocassette recording) enabled the video data to be stored, which increased the use of video surveillance. Today, video surveillance is used in many commercial, residential, and military contexts.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating a monitored environment, according to an embodiment;

FIG. 2 is a flowchart illustrating operation at a camera, according to an embodiment;

FIG. 3 is a flowchart illustrating operation of a video processing system, according to an embodiment;

FIG. 4 is an illustration of a video composition including video clips over a time period, according to an embodiment;

FIG. 5 is a block diagram illustrating a system for video processing, according to an embodiment;

FIG. 6 is a block diagram illustrating a system for video processing, according to an embodiment;

FIG. 7 is a flowchart illustrating a method of video processing, according to an embodiment; and

FIG. 8 is a block diagram illustrating an example machine upon which any one or more of the techniques (e.g., methodologies) discussed herein may perform, according to an example embodiment.

### DETAILED DESCRIPTION

Systems and methods described herein provide mechanisms for implementing a smart tracking video recorder. With the decreased cost of cameras and related equipment, the number of cameras used in a video surveillance system (VSS) has increased. In a VSS installation with several cameras where each camera has a limited view of an entire property or area of coverage, it becomes difficult to identify and extract relevant video from the video data of the several cameras. In addition, there is added cost to store video from several cameras, both in terms of initial equipment costs and the ongoing costs of power and maintenance.

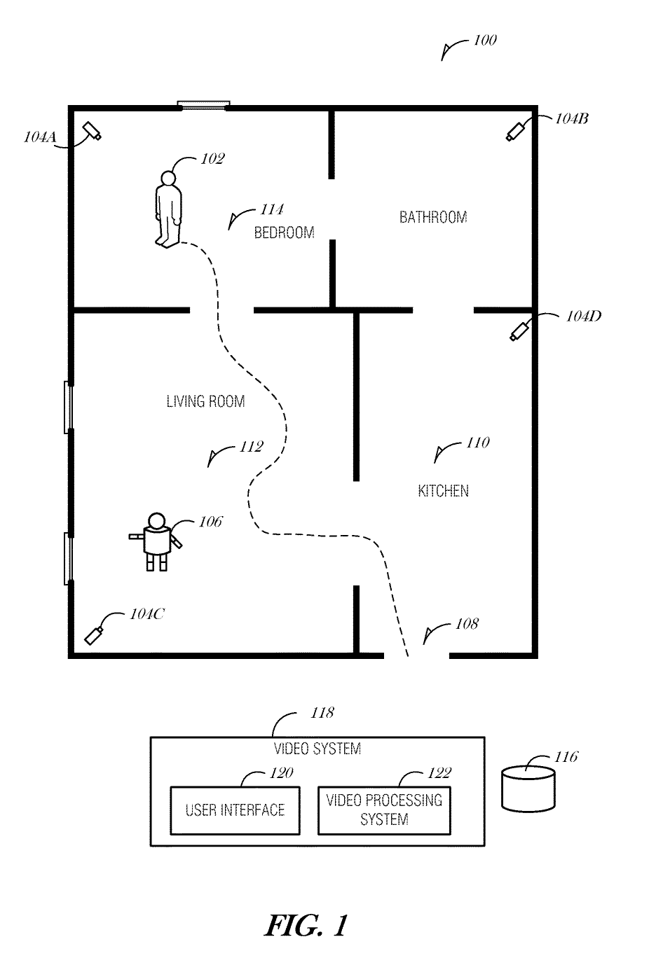

FIG. 1 is a diagram illustrating a monitored environment 100, according to an embodiment. FIG. 1 includes a user 102 (e.g., a homeowner, a patron, or a thief) who moves about the monitored environment 100. A video surveillance system (VSS) tracks the user 102 as he moves. The VSS may include one or more cameras 104A, 104B, 104C, 104D (collectively referred to as 104) to capture the user's movement, actions, or other aspects of the user 102 as the user 102 moves about in the monitored environment 100. The VSS may include infrared cameras for enabling night vision or other thermal imaging solutions. The infrared cameras may implement active illumination in the near infrared spectrum or the shortwave infrared band. The infrared cameras may alternatively operate with image intensification. The VSS may include visible light cameras. The cameras 104 in the VSS may be connected using wired or wireless connections. In addition, one or more of the cameras 104 in the VSS may use on or more servos for pan and tilt to follow a subject while it is within the operating field of view of the camera 104. The camera 104 may track a subject using shape recognition or with a physical marker that the subject holds or wears and the camera 104 actively tracks. The physical marker may be wireless connected to the camera 104 using a technology such as Bluetooth.

In addition to fixed cameras 104, the VSS may include a mobile camera, such as one incorporated into a service robot 106. A semi or fully autonomous robot may be used in various residential, commercial, medical, or military settings to assist human living or working these environments. A service robot 106 may be outfitted with one or more cameras for self-navigation, sensory input, and the like. One or more robot cameras may be used for surveillance or monitoring. For example, a robot may be used as an assistant for an elderly or disabled person. The robot may assist the person by fetching food, helping the person stand up from or sit into a chair, or answering the door. While the service robot 106 is in the person's presence, the service robot 106 may provide another camera 104 in the VSS. However, the service robot 106 may not be able to maintain contact monitoring over the person. For example, the robot may be sent away to perform one or more tasks, to recharge a battery, or just because the robot's presence is annoying to the person. As such, the robot's video feed alone is likely insufficient for a full-time video surveillance operation.

As illustrated in FIG. 1, the user 102 may traverse from an entry area 108, through a kitchen area 110, a living room area 112, and into a bedroom 114. The cameras 104 may be configured to continuously record. As such, then in this example the four cameras 104 may capture the user 102 as she enters a room, moves about, and exits. However, some cameras (e.g., the bathroom camera) may record no useful information because the user 102 is never in the field of view of that camera.

As an alternative to continuously recording, one or more of the cameras 104 may only record video data when there is a subject in view. The camera 104 may be adapted to detect motion or to detect a particular subject. The subject may be a person, an animal (e.g., a pet cat or dog), or another object (e.g., a robot). A motion detection sensor may be coupled to a camera 104 such that when a threshold amount of motion is detected, the camera 104 may begin to record video data. In such a system, the camera 104 may be initially powered off and the motion detection sensor may wake the camera 104 to begin capturing video. A threshold amount of motion may be needed before the camera 104 begins recording. The threshold amount may be measured in time, for example, three seconds of movement may be a trigger threshold before recording. In some examples, there is no threshold amount of detected movement; any movement may trigger recording. It is understood that in this type of unconstrained system, there may be some false positives, such as a tree moving in a window, a cat wandering about on the floor, or the service robot 106 moving about the room. To avoid such false positives, the cameras 104 may be configured to recognize the subject of interest before recording. There are various mechanisms that may be used to recognize the subject of interest including, but not limited to facial recognition, posture recognition, voice recognition, recognizing a transmitter carried or worn by the subject of interest, or the like.

As the cameras 104 operate, one or more video streams are saved to a storage device 116. The storage device 116 may be onsite or remote from the monitored environment 100. The cameras 104 may be configured to store a threshold amount of video, such as a running most-recent twenty minutes. Video footage older than twenty minutes would then be discarded. The video storage threshold may be the same for all cameras 104 or may differ. The video storage threshold may be configurable, such as be a user 102 or an administrator. The video storage threshold may be a function of the available storage space on the storage device 116. For example, the video storage threshold may be set to record video up to when the storage device 116 is at 90% capacity, after which the oldest video content is deleted on a rolling basis.

A person (e.g., user 102) may access a video system 118, which may be used to access the stored video from the storage device 116. The video system 118 may be a web-based system, a local server system, a cloud service, or any other computing platform. The video system 118 may include a user interface 120 where the person using the video system 118 is able to request footage from a certain timeframe. The user interface 120 may include a begin time and an end time input control. These controls provide a way to define the timeframe of interest. This timeframe of interest is used by the video processing system 122, which accesses the video content on the storage device 116, identifies appropriate segments from each video stream of each respective camera 104, and stitches the appropriate video segments together to form an output video stream with temporal continuity. The output stream is then presented via the user interface 120.

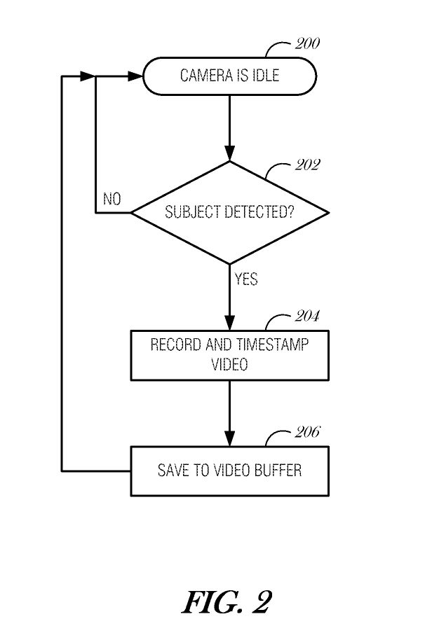

FIG. 2 is a flowchart illustrating operation at a camera 104, according to an embodiment. At the initial stage 200, the camera is idle. At decision block 202, the camera determines whether a subject is detected. The subject may be a person, an animal (e.g., a pet cat), a robot, or other thing. If the result of the determination is negative, then the camera returns to the idle state 200. When a subject is detected, the camera begins to record (operation 204), timestamping the video as it is recorded. The video is saved to a video buffer (operation 206). The video buffer may be a set size, such as twenty minutes of footage or 500 MB, and the system may be configured to save the most recent video in the video buffer in a first-in-first-out (FIFO) manner.

The subject may be detected (decision block 202) in various ways. In an embodiment, a person may carry, wear, or have implanted a token. The token may be a radio-frequency identifier (RFID) associated with the person. In other embodiments, the token is a transmitter that uses a short-range protocol, such as Bluetooth or near-field communications (NFC), and when the transmitter is queried, it responds with an identifier, which is associated with the person. Other communication protocols may be used as well, such as a cellular network, Wi-Fi network, or other radio network. The camera or another associated system may obtain the person's identification via the token and record video of the person based on the identification. The token may be used by the camera to frame the person. For example, the token may be continually or regularly omit an infrared (IR) beacon, which the camera may use to track (e.g., pan, tilt, and zoom) using an IR detector. Alternatively, other types of transmitters may be used, such as a Bluetooth transmitter paired to the video surveillance system.

Another mechanism to detect a subject (decision block 202) is to perform image analysis to identify a person's face or body. Morphology analysis may be used to distinguish a human body from other moving objects (e.g., cats, dogs, robots). More advanced systems may use facial recognition to identify the person. Combinations of image analysis and token-based systems may be used.

Another mechanism to detect a subject (decision block 202) is to use voice analysis. The cameras may be activated by passive voice analysis, such as by monitoring for sounds and when identifying a particular person's voice, beginning recording. The cameras may be activated by active voice analysis, for example, the person may issue a voice command to activate the recording. Voice analysis may be used in conjunction with token-based identification or image analysis.

Similarly, when the subject is non-human, such as an animal, the subject may be implanted with or wear an RFID tag, or may be recognized by its shape (e.g., morphology), color, or other distinguishing features (e.g., facial detection).

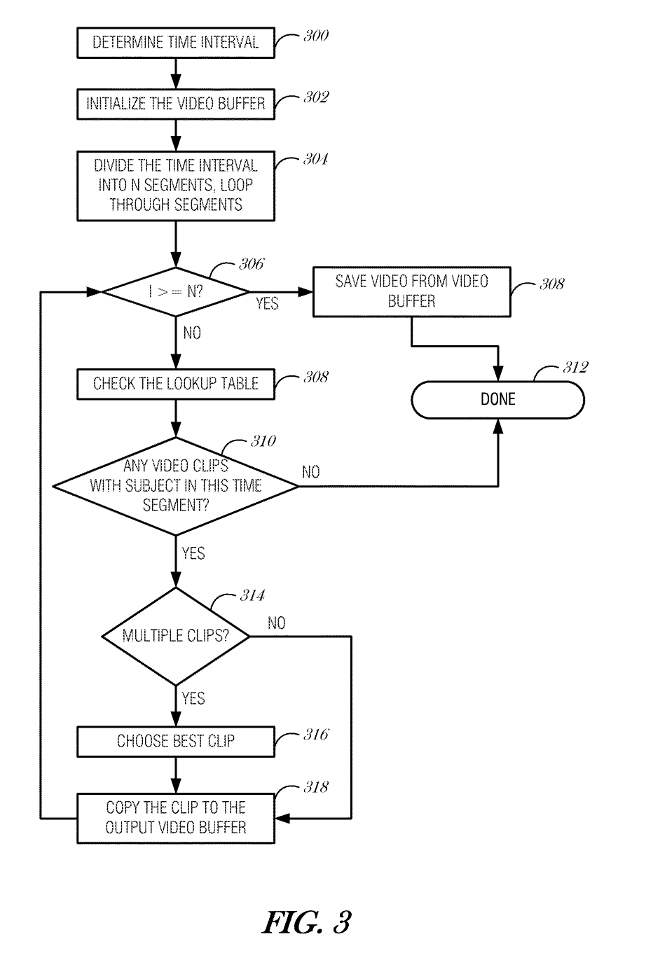

FIG. 3 is a flowchart illustrating operation of a video processing system, according to an embodiment. The video processing system may be one or more compute machines able to access one or more data sources (e.g., storage device 116) and video contents stored thereon. In an embodiment, the video contents are video clips from one or more cameras, such as cameras 104 from FIG. 1. The video clips include timestamps, which may be used to synchronize the output video.

At block 300, a time interval is determined. The time interval may be received from a user. The time interval may be divided into a number of equal segments. For example, the time interval may be a twenty minute interval with 400 distinct five second segments. As another example, the segment length may be one second and the overall time interval may be five minutes, resulting in 300 distinct segments.

At block 302, an output video buffer is initialized. The output video buffer may be memory allocated in main memory (e.g., random access memory) of a compute device in the video processing system.

At block 304, the time interval is divided into n segments. The size or number of segments may be user configurable. The segments may be any period, for example, from 0.1 seconds to 5 second lengths, or even longer. There are tradeoffs with longer length segments. Segments with a shorter length may result in a more consistent output video where the subject of the video is in nearly every frame of video. However, processing segments comes at a computational cost, so the few segments needed to be processed may increase processing efficiency, but at the risk of using footage that does not include the subject.

At decision block 306, the loop counter i is checked to determine whether the number of iterations of the loop is greater than or equal to the number of segments. Depending on how the loop counter i is initialized (e.g., starting with 0 or with 1), the comparison operator may change. Although a procedural iterative processing of the segments is described herein, other loop expressions may be used (e.g., a while loop) or other techniques may be used (e.g., recursion).

At block 308, when the number of iterations has not exceeded the number of segments, then a data structure (e.g., a table) may be checked to determine whether any video clip from any of the cameras include the subject. A preprocessing step may be used to analyze the video clips to determine whether a subject (e.g., a particular person) is included in the video clip and then populate a data structure (e.g., a table) with the timestamp of the video (e.g., beginning and ending of video) and whether a subject is in the video. This preprocessing may be performed by the video processing system 122 or by each camera 104 as it records clips. For example, when a camera begins recording, an entry may be made in the data structure indicating a start recording time, and when the recording is finished, the end recording time may be entered into the data structure. The data structure updates may occur at different times as well, for example, having both the start and end timestamps recorded after the video clip is done recording.

At decision block 310, it is determined whether any video clip for the i-th segment captured a subject. This may be performed by scanning the data structure to determine if any camera recorded a video clip at the appropriate time. If the determination is negative, then the processing may end (block 312).

When at least one video clip associated with the i-th segment includes the subject, then at decision block 314, it is determined whether multiple video clips exist. This may be the case when the person was in the field of view of multiple cameras. If multiple video clips containing the person exist, then at block 316, the “best” video clip is selected. The best video clip may be judged based on various factors, such as whether the person's face is visible, whether lighting is sufficient, how obscured the person is in the video clips, and the like. In an embodiment, the best video clip is based on which clip includes the face or front of the person.

At block 318, the video clip for the i-th segment is copied to the video buffer. The loop counter i is incremented and the control moves back to block 306 to check the loop counter.

After all i segments are processed, the resulting aggregated video is output from the video buffer at block 320, and the process completes.

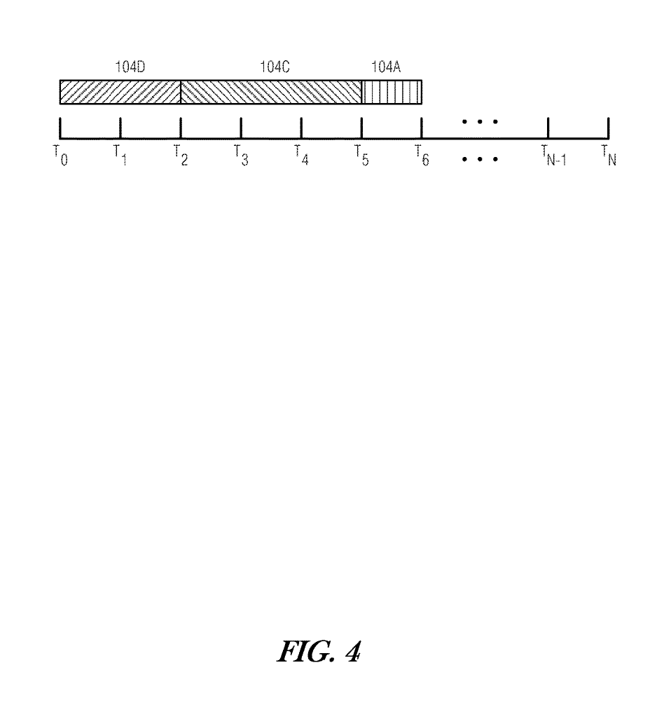

FIG. 4 is an illustration of a video composition including video clips over a time period, according to an embodiment. In FIG. 4, the time period is split into n segments. From time marker t₀ to t₂, the camera 104D in the kitchen may have footage of the person entering the home. From time marker t₂ to t₅, the camera 104C in the living room may have footage. From time marker t₅ to some later time marker, the camera 104A in the bedroom may have footage of the person. It is understood that around time markers t₂ and t₅, several cameras may have footage of the person, but due to the way the person is positioned or other aspects of the footage, a video clip from the living room camera 104C is used over the clip from 104D when the person is exiting the kitchen and entering the living room, for example.

The video composition illustrated in FIG. 4 may be obtained by processing each time segment in sequence. For example, consider a situation where the length of the video buffer is twenty minutes and the time segments are configured at ten seconds a piece. In this instance, for each ten seconds starting twenty minutes from the last recorded timestamp, videos that are available for that time period (e.g., −00:20:00 to −00:19:50) may be evaluated to determine whether any of the videos include the subject of interest and if there is more than one video available that includes the subject, then a choice is made to identify the video segment that is better (e.g., the person's face is visible in one video and not in another). Then, for the first segment, a ten second video clip is identified and stored in an output video buffer. After the first segment is processed, the next segment (e.g., −00:19:50 to −00:19:40) is processed. It is understood that two or more segments may be processed in parallel.

The output video from time markers t₀ to tₙ, includes a substantially continual footage of the subject with temporal consistency. By using timestamps, the video clips may be spliced together in a manner to maintain this temporal consistency. It is understood that with larger segmentation of the time period, there may be some situations where the output video does not include the subject. With a small enough time segmentation (e.g., 1 second), this situation may be avoided.

The output video may be useful in a wide variety of situations. For example, when monitoring an elderly person, a temporally consistent video with just the person may help first responders understand the context, nature, or situation of an emergent event.

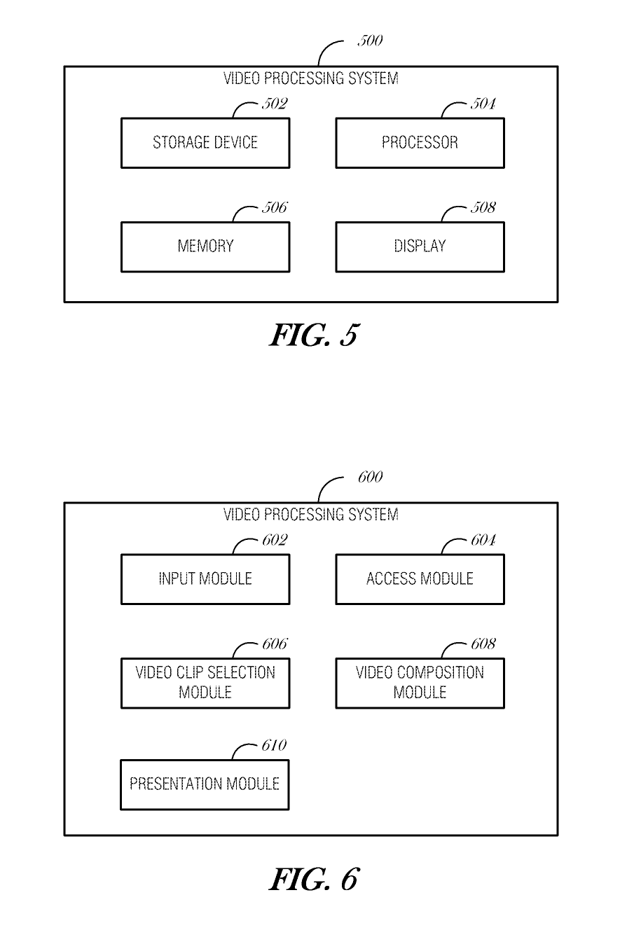

FIG. 5 is a block diagram illustrating a system 500 for video processing, according to an embodiment. The system 500 includes a storage device 502, a processor 504, and a memory 506. The memory 506 may include instructions, which when executed on the processor 504, cause the processor 504 to receive a time interval, the time interval divided into a plurality of segments. The processor 504 may access from the storage device 502, a plurality of video clips, each of the plurality of video clips including a timestamp. For each of the plurality of segments in the time interval, the processor 504 may determine a candidate video clip of the plurality of video clips, the candidate video clip including a subject in the candidate video clip. The processor 504 may then compose an output video that includes the candidate video clip of each segment of the plurality of segments and output the output video to a display 508.

In an embodiment, to receive the time interval, the processor 504 is to prompt a user for a begin time and an end time and calculate the time interval based on the begin time and the end time.

In an embodiment, the time interval is a duration used in a storage buffer. For example, if the storage buffer duration is twenty minutes, then the time interval may be set at twenty minutes.

In an embodiment, the storage buffer is a first-in-first-out buffer. A first-in-first-out (FIFO) buffer maintains the last x minutes (or seconds) of video in a circular queue.

In an embodiment, each of the plurality of segments are of equal length. The segments may be any length, such as five seconds, 1 second, 0.5 second, 3 minute, etc., so long as the number of segments divide equally into the total time interval used.

In an embodiment, to determine the candidate video clip from the plurality of video clips, the processor 504 is to identify a plurality of potential candidate video clips for a particular segment of the plurality of segments, each of the plurality of potential candidate video clips including the subject and determine the candidate video clip from the plurality of potential candidate video clips. In a further embodiment, to determine the candidate video clip from the plurality of potential candidate video clips, the processor 504 is to analyze each of the potential candidate video clips to determine a position of the subject in each of the potential candidate video clips and select the candidate video clip from the plurality of potential candidate video clips based on the position of the subject. In an embodiment, the position of the subject includes a direction the subject is facing.

In an embodiment, the plurality of video clips are produced by a respective plurality of cameras. In a further embodiment, a camera of the plurality of cameras is configured to record a video clip of the plurality of video clips when the subject is in view of the camera. In an embodiment, the camera is configured to record the video clip after the subject is recognized. Various mechanisms may be used to recognize a subject, such as an on-person device, facial recognition, posture recognition, voice recognition, or the like. In an embodiment, the camera is configured to recognize the subject based on a token used by the subject. In a further embodiment, the token includes a radio frequency identification tag. In an embodiment, the camera is configured to recognize the subject based on image analysis. In an embodiment, the camera is configured to recognize the subject based on voice analysis of the subject.

FIG. 6 is a block diagram illustrating a system 600 for video processing, according to an embodiment. The system 600 may include an input module 602 to receive a time interval, the time interval divided into a plurality of segments. Further, the system 600 may include an access module 604 to access from a storage device, a plurality of video clips, each of the plurality of video clips including a timestamp. The system 600 may include a video clip selection module 606 to analyze each of the plurality of segments in the time interval to determine a candidate video clip of the plurality of video clips, the candidate video clip including a subject in the candidate video clip. A video composition module 608 is then used to compose an output video that includes the candidate video clip of each segment of the plurality of segments. A presentation module 610 is used to output the output video to a display.

The subject of the video may be any person, animal (e.g., pet), or other object (e.g., a service robot) that may move about an environment. The subject may be identified by a user or an administrator. Various systems may be trained or initialized to identify the subject, such as by providing a picture of the subject's face for later facial analysis or an identification number to be used to match an RFID tag. In an embodiment, the subject is a person. In an embodiment, the subject is an animal.

In an embodiment, to receive the time interval, the input module 602 is to prompt a user for a begin time and an end time and calculate the time interval based on the begin time and the end time. The begin time and the end time may be constrained by the available video and the corresponding timestamps of the video.

In an embodiment, the time interval is a duration used in a storage buffer. For example, a storage buffer may be able to hold thirty minutes of video. In this case, the duration may be thirty minutes. In an embodiment, the storage buffer is a first-in-first-out buffer.

In an embodiment, each of the plurality of segments are of equal length. It is understood that segments may be of different length, in which case the temporal alignment becomes more complex and may involve clipping video segments to align successive segments.

In an embodiment, to determine the candidate video clip from the plurality of video clips, the video clip selection module 606 is to identify a plurality of potential candidate video clips for a particular segment of the plurality of segments, each of the plurality of potential candidate video clips including the subject and determine the candidate video clip from the plurality of potential candidate video clips. In a further embodiment, to determine the candidate video clip from the plurality of potential candidate video clips, the video clip selection module 606 is to analyze each of the potential candidate video clips to determine a position of the subject in each of the potential candidate video clips and select the candidate video clip from the plurality of potential candidate video clips based on the position of the subject. In a further embodiment, the position of the subject includes a direction the subject is facing.

In an embodiment, the plurality of video clips are produced by a respective plurality of cameras. In an embodiment, a camera of the plurality of cameras is configured to record a video clip of the plurality of video clips when the subject is in view of the camera. In an embodiment, the camera is configured to record the video clip after the subject is recognized. In an embodiment, the camera is configured to recognize the subject based on a token used by the subject. In an embodiment, the token includes a radio frequency identification tag. In another embodiment, the camera is configured to recognize the subject based on image analysis. In another embodiment, the camera is configured to recognize the subject based on voice analysis of the subject.

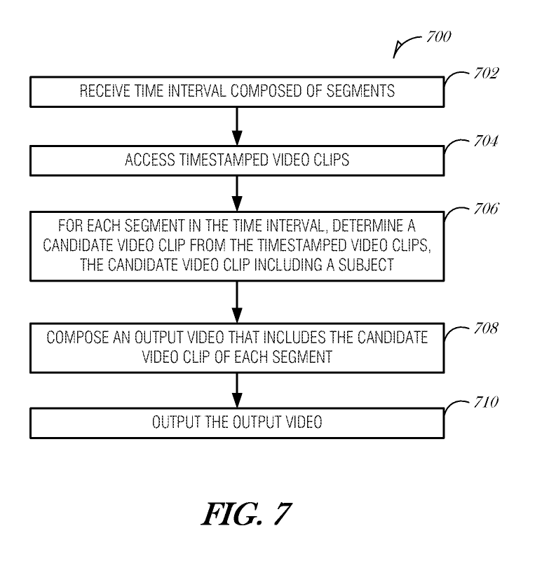

FIG. 7 is a flowchart illustrating a method 700 of video processing, according to an embodiment. At block 702, at a computer-based video processing system, a time interval is received, where the time interval divided into a plurality of segments. In an embodiment, receiving the time interval comprises prompting a user for a begin time and an end time and calculating the time interval based on the begin time and the end time. For example, a user may provide a begin time and an end time within the video storage window. The window may be a set time, such as twenty minutes or saved video using a FIFO mechanism. The begin time and the end time may be within the twenty minute period, such as from 00:11:00 to 00:12:30 of the twenty minute (e.g., 00:20:00) window. The begin time and the end time may be set by default to begin at the start of the rolling window period (e.g., −00:20:00) and end at the end of the rolling window period (e.g., 00:00:00).

In an embodiment, the time interval is a duration used in a storage buffer. In a further embodiment, the storage buffer is a first-in-first-out buffer.

In an embodiment, each of the plurality of segments are of equal length. While the segments do not have to be the same length, the processing may be simpler when they are. However, there is no limitation on the segment lengths.

At block 704, a plurality of video clips is accessed by the computer-based video processing system, where each of the plurality of video clips including a timestamp. In an embodiment, the plurality of video clips are produced by a respective plurality of cameras. In a further embodiment, a camera of the plurality of cameras is configured to record a video clip of the plurality of video clips when the subject is in view of the camera.

At block 706, for each of the plurality of segments in the time interval, a candidate video clip of the plurality of video clips is determined, where the candidate video clip includes a subject in the candidate video clip.

In some cases, more than one video clip may have the subject in view. Thus, in an embodiment, determining the candidate video clip from the plurality of video clips comprises: identifying a plurality of potential candidate video clips for a particular segment of the plurality of segments, each of the plurality of potential candidate video clips including the subject and determining the candidate video clip from the plurality of potential candidate video clips. In these cases, one video clip is chosen based on one or more criteria, such as whether the person is facing the camera, if the lighting is good, whether the person is obscured by foreground objects, etc. Thus, in further embodiments, determining the candidate video clip from the plurality of potential candidate video clips comprises analyzing each of the potential candidate video clips to determine a position of the subject in each of the potential candidate video clips and selecting the candidate video clip from the plurality of potential candidate video clips based on the position of the subject. In a further embodiment, the position of the subject includes a direction the subject is facing.

In another embodiment, the camera is configured to record the video clip after the subject is recognized. In a further embodiment, the camera is configured to recognize the subject based on a token used by the subject. In a further embodiment, the token includes a radio frequency identification tag. In another embodiment, the camera is configured to recognize the subject based on image analysis. In an embodiment, the camera is configured to recognize the subject based on voice analysis of the subject.

At block 708, an output video that includes the candidate video clip of each segment of the plurality of segments is composed by the computer-based video processing system.

At block 710, the output video is output. The output video may be output to a file, displayed on an electronic display, projected, or otherwise presented to one or more users.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules, components, or mechanisms may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

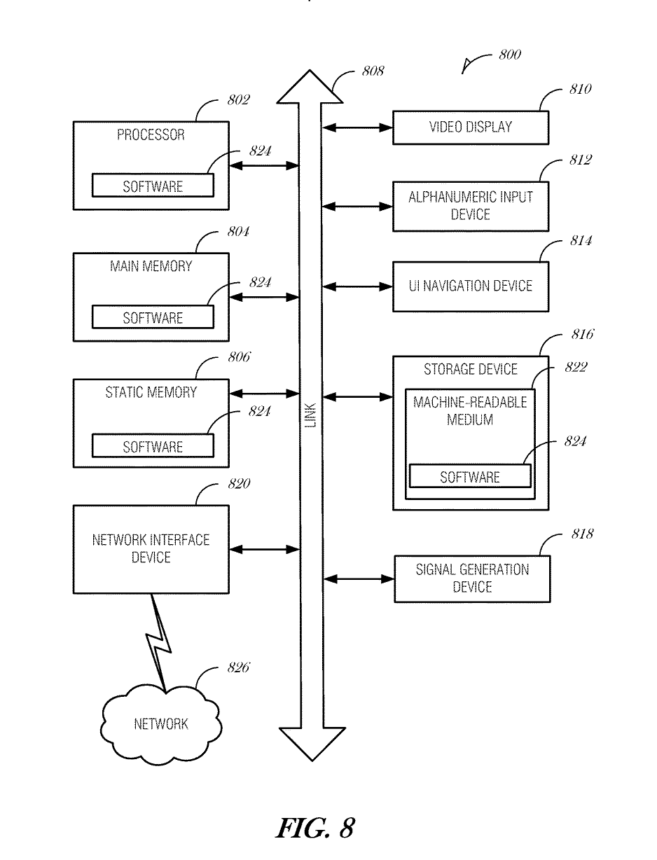

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter for video processing (such as a device, apparatus, or machine) comprising: a storage device; a processor; and a memory, including instructions, which when executed on the processor, cause the processor to: receive a time interval, the time interval divided into a plurality of segments; access from the storage device, a plurality of video clips, each of the plurality of video clips including a timestamp; for each of the plurality of segments in the time interval, determine a candidate video clip of the plurality of video clips, the candidate video clip including a subject in the candidate video clip; compose an output video that includes the candidate video clip of each segment of the plurality of segments; and output the output video to a display.

In Example 2, the subject matter of Example 1 may include, wherein the subject is a person.

In Example 3, the subject matter of any one of Examples 1 to 2 may include, wherein the subject is an animal.

In Example 4, the subject matter of any one of Examples 1 to 3 may include, wherein to receive the time interval, the processor is to: prompt a user for a begin time and an end time; and calculate the time interval based on the begin time and the end time.

In Example 5, the subject matter of any one of Examples 1 to 4 may include, wherein the time interval is a duration used in a storage buffer.

In Example 6, the subject matter of any one of Examples 1 to 5 may include, wherein the storage buffer is a first-in-first-out buffer.

In Example 7, the subject matter of any one of Examples 1 to 6 may include, wherein each of the plurality of segments are of equal length.

In Example 8, the subject matter of any one of Examples 1 to 7 may include, wherein to determine the candidate video clip from the plurality of video clips, the processor is to: identify a plurality of potential candidate video clips for a particular segment of the plurality of segments, each of the plurality of potential candidate video clips including the subject; and determine the candidate video clip from the plurality of potential candidate video clips.

In Example 9, the subject matter of any one of Examples 1 to 8 may include, wherein to determine the candidate video clip from the plurality of potential candidate video clips, the processor is to: analyze each of the potential candidate video clips to determine a position of the subject in each of the potential candidate video clips; and select the candidate video clip from the plurality of potential candidate video clips based on the position of the subject.

In Example 10, the subject matter of any one of Examples 1 to 9 may include, wherein the position of the subject includes a direction the subject is facing.

In Example 11, the subject matter of any one of Examples 1 to 10 may include, wherein the plurality of video clips are produced by a respective plurality of cameras.

In Example 12, the subject matter of any one of Examples 1 to 11 may include, wherein a camera of the plurality of cameras is configured to record a video clip of the plurality of video clips when the subject is in view of the camera.

In Example 13, the subject matter of any one of Examples 1 to 12 may include, wherein the camera is configured to record the video clip after the subject is recognized.

In Example 14, the subject matter of any one of Examples 1 to 13 may include, wherein the camera is configured to recognize the subject based on a token used by the subject.

In Example 15, the subject matter of any one of Examples 1 to 14 may include, wherein the token includes a radio frequency identification tag.

In Example 16, the subject matter of any one of Examples 1 to 15 may include, wherein the camera is configured to recognize the subject based on image analysis.

In Example 17, the subject matter of any one of Examples 1 to 16 may include, wherein the camera is configured to recognize the subject based on voice analysis of the subject.

Example 18 includes subject matter for video processing (such as a method, means for performing acts, machine readable medium including instructions that when performed by a machine cause the machine to performs acts, or an apparatus to perform) comprising: receiving a time interval, at a computer-based video processing system, the time interval divided into a plurality of segments; accessing, by the computer-based video processing system, a plurality of video clips, each of the plurality of video clips including a timestamp; for each of the plurality of segments in the time interval, determining a candidate video clip of the plurality of video clips, the candidate video clip including a subject in the candidate video clip; composing, by the computer-based video processing system, an output video that includes the candidate video clip of each segment of the plurality of segments; and outputting the output video.

In Example 19, the subject matter of Example 18 may include, wherein the subject is a person.

In Example 20, the subject matter of any one of Examples 18 to 19 may include, wherein the subject is an animal.

In Example 21, the subject matter of any one of Examples 18 to 20 may include, wherein receiving the time interval comprises: prompting a user for a begin time and an end time; and calculating the time interval based on the begin time and the end time.

In Example 22, the subject matter of any one of Examples 18 to 21 may include, wherein the time interval is a duration used in a storage buffer.

In Example 23, the subject matter of any one of Examples 18 to 22 may include, wherein the storage buffer is a first-in-first-out buffer.

In Example 24, the subject matter of any one of Examples 18 to 23 may include, wherein each of the plurality of segments are of equal length.

In Example 25, the subject matter of any one of Examples 18 to 24 may include, wherein determining the candidate video clip from the plurality of video clips comprises: identifying a plurality of potential candidate video clips for a particular segment of the plurality of segments, each of the plurality of potential candidate video clips including the subject; and determining the candidate video clip from the plurality of potential candidate video clips.

In Example 26, the subject matter of any one of Examples 18 to 25 may include, wherein determining the candidate video clip from the plurality of potential candidate video clips comprises: analyzing each of the potential candidate video clips to determine a position of the subject in each of the potential candidate video clips; and selecting the candidate video clip from the plurality of potential candidate video clips based on the position of the subject.

In Example 27, the subject matter of any one of Examples 18 to 26 may include, wherein the position of the subject includes a direction the subject is facing.

In Example 28, the subject matter of any one of Examples 18 to 27 may include, wherein the plurality of video clips are produced by a respective plurality of cameras.

In Example 29, the subject matter of any one of Examples 18 to 28 may include, wherein a camera of the plurality of cameras is configured to record a video clip of the plurality of video clips when the subject is in view of the camera.

In Example 30, the subject matter of any one of Examples 18 to 29 may include, wherein the camera is configured to record the video clip after the subject is recognized.

In Example 31, the subject matter of any one of Examples 18 to 30 may include, wherein the camera is configured to recognize the subject based on a token used by the subject.

In Example 32, the subject matter of any one of Examples 18 to 31 may include, wherein the token includes a radio frequency identification tag.

In Example 33, the subject matter of any one of Examples 18 to 32 may include, wherein the camera is configured to recognize the subject based on image analysis.

In Example 34, the subject matter of any one of Examples 18 to 33 may include, wherein the camera is configured to recognize the subject based on voice analysis of the subject.

Example 35 includes at least one machine-readable medium including instructions, which when executed by a machine, cause the machine to perform operations of any of the Examples 18-34.

Example 36 includes an apparatus comprising means for performing any of the Examples 18-34.

Example 37 includes subject matter for video processing (such as a device, apparatus, or machine) comprising: means for receiving a time interval, at a computer-based video processing system, the time interval divided into a plurality of segments; means for accessing, by the computer-based video processing system, a plurality of video clips, each of the plurality of video clips including a timestamp; means for processing each of the plurality of segments in the time interval and determining a candidate video clip of the plurality of video clips, the candidate video clip including a subject in the candidate video clip; means for composing, by the computer-based video processing system, an output video that includes the candidate video clip of each segment of the plurality of segments; and means for outputting the output video.

In Example 38, the subject matter of Example 37 may include, wherein the subject is a person.

In Example 39, the subject matter of any one of Examples 37 to 38 may include, wherein the subject is an animal.

In Example 40, the subject matter of any one of Examples 37 to 39 may include, wherein the means for receiving the time interval comprise: means for prompting a user for a begin time and an end time; and means for calculating the time interval based on the begin time and the end time.

In Example 41, the subject matter of any one of Examples 37 to 40 may include, wherein the time interval is a duration used in a storage buffer.

In Example 42, the subject matter of any one of Examples 37 to 41 may include, wherein the storage buffer is a first-in-first-out buffer.

In Example 43, the subject matter of any one of Examples 37 to 42 may include, wherein each of the plurality of segments are of equal length.

In Example 44, the subject matter of any one of Examples 37 to 43 may include, wherein the means for determining the candidate video clip from the plurality of video clips comprise: means for identifying a plurality of potential candidate video clips for a particular segment of the plurality of segments, each of the plurality of potential candidate video clips including the subject; and means for determining the candidate video clip from the plurality of potential candidate video clips.

In Example 45, the subject matter of any one of Examples 37 to 44 may include, wherein the means for determining the candidate video clip from the plurality of potential candidate video clips comprise: means for analyzing each of the potential candidate video clips to determine a position of the subject in each of the potential candidate video clips; and means for selecting the candidate video clip from the plurality of potential candidate video clips based on the position of the subject.

In Example 46, the subject matter of any one of Examples 37 to 45 may include, wherein the position of the subject includes a direction the subject is facing.

In Example 47, the subject matter of any one of Examples 37 to 46 may include, wherein the plurality of video clips are produced by a respective plurality of cameras.

In Example 48, the subject matter of any one of Examples 37 to 47 may include, wherein a camera of the plurality of cameras is configured to record a video clip of the plurality of video clips when the subject is in view of the camera.

In Example 49, the subject matter of any one of Examples 37 to 48 may include, wherein the camera is configured to record the video clip after the subject is recognized.

In Example 50, the subject matter of any one of Examples 37 to 49 may include, wherein the camera is configured to recognize the subject based on a token used by the subject.

In Example 51, the subject matter of any one of Examples 37 to 50 may include, wherein the token includes a radio frequency identification tag.

In Example 52, the subject matter of any one of Examples 37 to 51 may include, wherein the camera is configured to recognize the subject based on image analysis.

In Example 53, the subject matter of any one of Examples 37 to 52 may include, wherein the camera is configured to recognize the subject based on voice analysis of the subject.

Example 54 includes subject matter for video processing (such as a device, apparatus, or machine) comprising: an input module to receive a time interval, the time interval divided into a plurality of segments; an access module to access from a storage device, a plurality of video clips, each of the plurality of video clips including a timestamp; a video clip selection module to, for each of the plurality of segments in the time interval, determine a candidate video clip of the plurality of video clips, the candidate video clip including a subject in the candidate video clip; a video composition module to compose an output video that includes the candidate video clip of each segment of the plurality of segments; and a presentation module to output the output video to a display.

In Example 55, the subject matter of Example 54 may include, wherein the subject is a person.

In Example 56, the subject matter of any one of Examples 54 to 55 may include, wherein the subject is an animal.

In Example 57, the subject matter of any one of Examples 54 to 56 may include, wherein to receive the time interval, the input module is to: prompt a user for a begin time and an end time; and calculate the time interval based on the begin time and the end time.

In Example 58, the subject matter of any one of Examples 54 to 57 may include, wherein the time interval is a duration used in a storage buffer.

In Example 59, the subject matter of any one of Examples 54 to 58 may include, wherein the storage buffer is a first-in-first-out buffer.

In Example 60, the subject matter of any one of Examples 54 to 59 may include, wherein each of the plurality of segments are of equal length.

In Example 61, the subject matter of any one of Examples 54 to 60 may include, wherein to determine the candidate video clip from the plurality of video clips, the video clip selection module is to: identify a plurality of potential candidate video clips for a particular segment of the plurality of segments, each of the plurality of potential candidate video clips including the subject; and determine the candidate video clip from the plurality of potential candidate video clips.

In Example 62, the subject matter of any one of Examples 54 to 61 may include, wherein to determine the candidate video clip from the plurality of potential candidate video clips, the video clip selection module is to: analyze each of the potential candidate video clips to determine a position of the subject in each of the potential candidate video clips; and select the candidate video clip from the plurality of potential candidate video clips based on the position of the subject.

In Example 63, the subject matter of any one of Examples 54 to 62 may include, wherein the position of the subject includes a direction the subject is facing.

In Example 64, the subject matter of any one of Examples 54 to 63 may include, wherein the plurality of video clips are produced by a respective plurality of cameras.

In Example 65, the subject matter of any one of Examples 54 to 64 may include, wherein a camera of the plurality of cameras is configured to record a video clip of the plurality of video clips when the subject is in view of the camera.

In Example 66, the subject matter of any one of Examples 54 to 65 may include, wherein the camera is configured to record the video clip after the subject is recognized.

In Example 67, the subject matter of any one of Examples 54 to 66 may include, wherein the camera is configured to recognize the subject based on a token used by the subject.

In Example 68, the subject matter of any one of Examples 54 to 67 may include, wherein the token includes a radio frequency identification tag.

In Example 69, the subject matter of any one of Examples 54 to 68 may include, wherein the camera is configured to recognize the subject based on image analysis.

In Example 70, the subject matter of any one of Examples 54 to 69 may include, wherein the camera is configured to recognize the subject based on voice analysis of the subject.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-26. (canceled)

27. A video processing system comprising:
a storage device;
a processor; and
a memory, including instructions, which when executed on the processor, cause the processor to:
receive a time interval, the time interval divided into a plurality of segments;
access from the storage device, a plurality of video clips, each of the plurality of video clips including a timestamp;
for each of the plurality of segments in the time interval, determine a candidate video clip of the plurality of video clips, the candidate video clip including a subject in the candidate video clip;
compose an output video that includes the candidate video clip of each segment of the plurality of segments; and
output the output video to a display.

28. The system of claim 27, wherein the subject is a person.

29. The system of claim 27, wherein the subject is an animal.

30. The system of claim 27, wherein to receive the time interval, the processor is to:
prompt a user for a begin time and an end time; and
calculate the time interval based on the begin time and the end time.

31. The system of claim 27, wherein the time interval is a duration used in a storage buffer.

32. The system of claim 31, wherein the storage buffer is a first-in-first-out buffer.

33. The system of claim 27, wherein each of the plurality of segments are of equal length.

34. The system of claim 27, wherein to determine the candidate video clip from the plurality of video clips, the processor is to:
identify a plurality of potential candidate video clips for a particular segment of the plurality of segments, each of the plurality of potential candidate video clips including the subject; and
determine the candidate video clip from the plurality of potential candidate video clips.

35. The system of claim 34, wherein to determine the candidate video clip from the plurality of potential candidate video clips, the processor is to:
analyze each of the potential candidate video clips to determine a position of the subject in each of the potential candidate video clips; and
select the candidate video clip from the plurality of potential candidate video clips based on the position of the subject.

36. The system of claim 35, wherein the position of the subject includes a direction the subject is facing.

37. The system of claim 27, wherein the plurality of video clips are produced by a respective plurality of cameras.

38. The system of claim 37, wherein a camera of the plurality of cameras is configured to record a video clip of the plurality of video clips when the subject is in view of the camera.

39. The system of claim 38, wherein the camera is configured to record the video clip after the subject is recognized.

40. The system of claim 39, wherein the camera is configured to recognize the subject based on a token used by the subject.

41. The system of claim 40, wherein the token includes a radio frequency identification tag.

42. The system of claim 39, wherein the camera is configured to recognize the subject based on image analysis.

43. The system of claim 39, wherein the camera is configured to recognize the subject based on voice analysis of the subject.

44. A method of video processing, the method comprising:
receiving a time interval, at a computer-based video processing system, the time interval divided into a plurality of segments;
accessing, by the computer-based video processing system, a plurality of video clips, each of the plurality of video clips including a timestamp;
for each of the plurality of segments in the time interval, determining a candidate video clip of the plurality of video clips, the candidate video clip including a subject in the candidate video clip;
composing, by the computer-based video processing system, an output video that includes the candidate video clip of each segment of the plurality of segments; and
outputting the output video.

45. The method of claim 44, wherein determining the candidate video clip from the plurality of video clips comprises:
identifying a plurality of potential candidate video clips for a particular segment of the plurality of segments, each of the plurality of potential candidate video clips including the subject; and
determining the candidate video clip from the plurality of potential candidate video clips.

46. The method of claim 45, wherein determining the candidate video clip from the plurality of potential candidate video clips comprises:
analyzing each of the potential candidate video clips to determine a position of the subject in each of the potential candidate video clips; and
selecting the candidate video clip from the plurality of potential candidate video clips based on the position of the subject.

47. The method of claim 46, wherein the position of the subject includes a direction the subject is facing.

48. At least one non-transitory machine-readable medium including instructions, which when executed by a machine, cause the machine to:
receive a time interval, the time interval divided into a plurality of segments;
access from the storage device, a plurality of video clips, each of the plurality of video clips including a timestamp;
for each of the plurality of segments in the time interval, determine a candidate video clip of the plurality of video clips, the candidate video clip including a subject in the candidate video clip;
compose an output video that includes the candidate video clip of each segment of the plurality of segments; and
output the output video to a display.

49. The at least one non-transitory machine-readable medium of claim 48, wherein the instructions to determine the candidate video clip from the plurality of video clips, comprise instructions to:
identify a plurality of potential candidate video clips for a particular segment of the plurality of segments, each of the plurality of potential candidate video clips including the subject; and
determine the candidate video clip from the plurality of potential candidate video clips.

50. The at least one non-transitory machine-readable medium of claim 49, wherein the instructions to determine the candidate video clip from the plurality of potential candidate video clips, comprise instructions to:
analyze each of the potential candidate video clips to determine a position of the subject in each of the potential candidate video clips; and
select the candidate video clip from the plurality of potential candidate video clips based on the position of the subject.
